(19) United States
(12) Patent Application Publication
(10) Pub. No.: US 2017/0058522 A1
(43) Pub. Date: Mar. 2, 2017

(54) Rodent Resistant Drywall

(71) Applicant: James Matthew Carroll, JR., Praine Hill, TX (US)

(72) Inventor: James Matthew Carroll, JR., Praine Hill, TX (US)

(21) Appl. No.: 14/842,737

(22) Filed: Sep. 1, 2015

(51) Int. Cl. E04B 2/00; B32B 13/06; E04C 2/04

(52) U.S. Cl. CPC E04C 2/44; E04C 2/04; B32B 13/06; B32B 2607/00

(57) ABSTRACT

Rodent Resistant Drywall is a drywall with an embedded metal aggregate.

### FIELD OF THE INVENTION

This invention relates to construction materials for dwellings with an emphasis on rodent resistance.

### BACKGROUND OF THE INVENTION

Rodent infestation has long been an issue for dwellings in residential, commercial, and recreational settings. Damage by rodents has been documented in homes, apartments, hotels, office complexes, retail businesses, manufacturing facilities, food processing and warehouse facilities, and a variety of other structures. Infestations are of particular concern to individuals living in rural or newly developed areas as rodents can carry and transmit a variety of diseases, such as salmonellosis, leptospirosis, and murine typhus, which are transmittable to humans. They may also transmit diseases to livestock and pets.

Rodents are capable of destroying insulation, electrical wiring, and other structural components of buildings which can be costly. Electrical fires may result from rodent compromised wiring threatening human safety. As such, a proactive, preventative method is desirable. Many traditional methods of rodent protection are used once a problem has already been established—using a reactive approach rather than a proactive one. These methods tend to be costly, require routine maintenance, and can be harmful to children, pets, and endangered species. The most effective means of limiting rodent damage is rodent-resistant construction. Rodent Resistant Drywall addresses the problem during the construction phase of a structure. New buildings should be designed and built with Rodent Resistant Drywall to prevent rodent entry.

Existing structures should be remodeled using Rodent Resistant Drywall. Constructing a rodent-resistant building is far less expensive than addressing rodent infestation later.

### BRIEF DESCRIPTION OF THE DRAWINGS OF THE PATENT PROTOTYPE

FIG. 1 depicts a piece of the rodent resistant drywall with two drill away holes cut into it.

FIG. 2 depicts the inside of the rodent resistant drywall.

FIG. 3 depicts a finished sheet of rodent resistant drywall as well as an opened side view of the rodent resistant drywall.

### DETAILED DESCRIPTION OF THE DRAWINGS OF THE PATENT PROTOTYPE

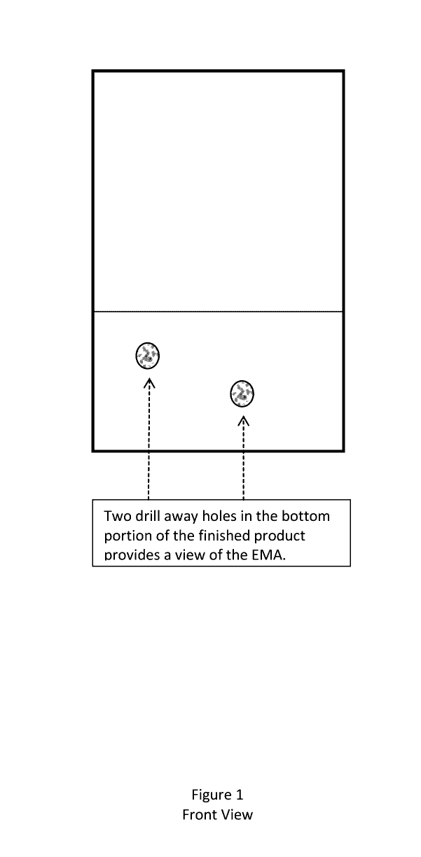

FIG. 1 depicts the finished rodent resistant drywall that has two drill away holes cut into it in order for the viewer to see a portion of the EMA that is enclosed.

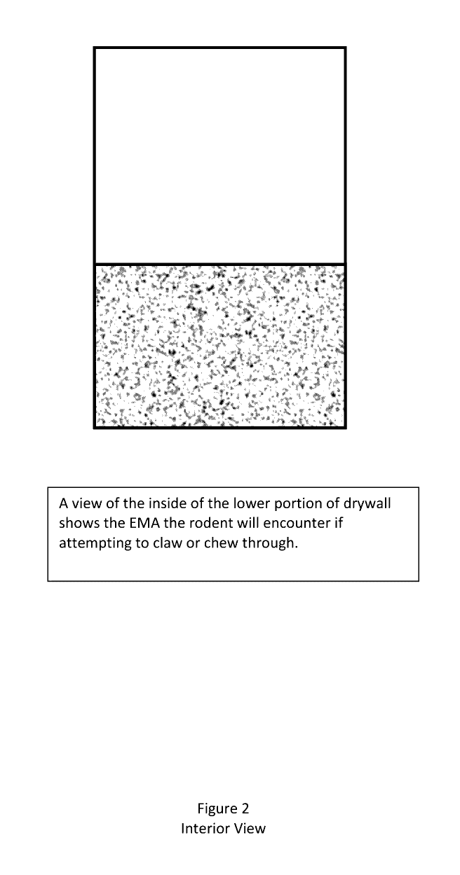

FIG. 2 depicts the inside of the rodent resistant drywall with the EMA exposed so the viewer can see the contents.

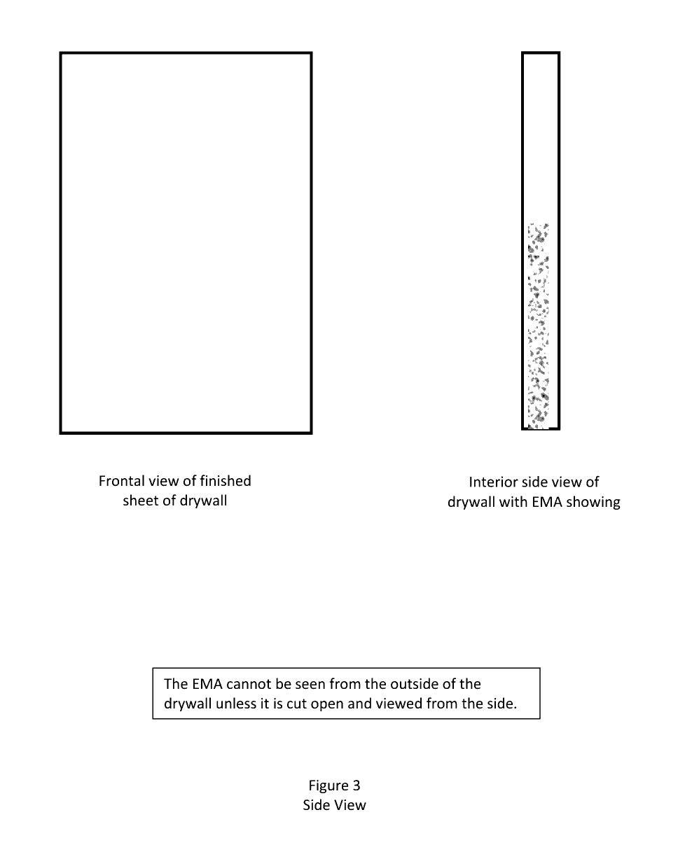

FIG. 3 depicts a finished sheet of rodent resistant drywall as well as a sheet of rodent resistant drywall that has been cut open on the side in order to display the otherwise invisible lining of EMA.

### SUMMARY

Rodent resistant drywall addresses the problem of rodent invasion.

Rodent resistant drywall provides a safer, more environmentally friendly alternative to traps, poisons, and sprays.

Rodent resistant drywall does not take up any additional space in a dwelling.

Rodent resistant drywall is a less costly alternative to reactive rodent protection initiatives.

Rodent resistant drywall offers built-in protection, eliminating the need for additional installation considerations.

Rodent resistant drywall offers unseen protection and poses no danger to children, pets, or endangered animals.

1. Embedded Metal Aggregate (EMA) forms a rodent resistant barrier when incorporated into drywall.
EMA can be integrated into the drywall at any ratio of coverage.
EMA is effective when placed in any pattern or shape within the drywall.
The EMA within the drywall will cause pain and injury to rodents attempting to claw or chew through the drywall.
The EMA may be added to the drywall in its construction state.
